(19) United States
(12) Patent Application Publication
(10) Pub. No.: US 2021/0158998 A1
(43) Pub. Date: May 27, 2021

(54) COMPOSITE MAGNETS AND METHODS OF MAKING COMPOSITE MAGNETS

(71) Applicant: Ford Global Technologies, LLC, Dearborn, MI (US)

(72) Inventor: Chuanbing RONG, Canton, MI (US)

(21) Appl. No.: 16/690,234

(22) Filed: Nov. 21, 2019

(51) Int. Cl. H01F 1/057

(52) U.S. Cl. CPC H01F 1/0579; H01F 7/02; H01F 1/0571

(57) ABSTRACT

A composite permanent magnet includes at least one magnetically-hard portion formed from a compacted powder material and at least one magnetically-soft portion mixed with the at least one magnetically-hard portion. The composite permanent magnet also includes a nonmagnetic outer coating portion applied to each magnetically-soft portion to isolate the coated magnetically-soft portion from magnetically-hard portions thereby inhibiting demagnetization of the at least one magnetically-hard portion.

### TECHNICAL FIELD

The present disclosure relates to a composite permanent magnet with magnetically-hard and magnetically-soft phases.

### BACKGROUND

Permanent magnets have a wide application due to persisted permanent flux. Rare earth permanent magnets, such as Nd—Fe—B or Sm—Co permanent magnets, include rare earth elements which display excellent hard magnetic performance, evidenced by high coercivity, high flux density, and, therefore, high energy density. Conventional Sm—Co and Nd—Fe—B magnets are costly due to low natural occurrence and have limited magnetic performance improvement capability.

One approach to improving magnetic performance in Sm—Co and Nd—Fe—B permanent magnets is to add a magnetically-soft phase, such as Fe and/or Fe—Co. The magnetically-soft phase has a high magnetic flux density which increases the remanence of the final magnet, and thus improves the resultant energy product application. Conventional composite magnets are formed by adding the magnetically-soft phase into NdFeB or SmCo, however these magnets do not achieve the magnetic performance over conventional sintered Nd—Fe—B magnets because although remanence is enhanced, coercivity is sacrificed.

Another approach to add magnetically-soft phases into the magnetically-hard phases includes using nanocomposite technology, such as melt-spinning, ball milling, or other similar techniques. In magnets prepared from those methods, the grain size of the magnetically-soft phase is extremely small (i.e., less than 100 nm).

### SUMMARY

A composite permanent magnet includes at least one first portion formed from a magnetically-hard material and at least one second portion formed from a magnetically-soft material intermixed with the first portion at a predetermined ratio. The composite permanent magnet also includes an outer coating portion formed from a nonmagnetic material circumscribing each second portion. Each outer coating portion isolates a respective second portion from the at least one first portion thereby inhibiting demagnetization of the at least one first portion.

A composite permanent magnet includes at least one magnetically-hard portion formed from a compacted powder material and at least one magnetically-soft portion mixed with the at least one magnetically-hard portion. The composite permanent magnet also includes a nonmagnetic outer coating portion applied to each magnetically-soft portion to isolate the coated magnetically-soft portion from magnetically-hard portions thereby inhibiting demagnetization of the at least one magnetically-hard portion.

A method of forming a composite permanent magnet includes providing a powder of magnetically-hard grains to form a first portion and providing a magnetically-soft material to form a second portion. The method also includes applying a nonmagnetic coating to the second portion and mixing the first portion and the coated second portion to a predetermined ratio. The method further includes hot-compacting the first portion and the second portion to form a compact and hot-deforming the compact to form a composite permanent magnet with elongated magnetically-hard grains embedded within an internal texture of the composite permanent magnet.

### BRIEF DESCRIPTION OF THE DRAWINGS

FIG. 1 is a plot depicting magnetic hysteresis curves of composite magnets having different grain sizes of respective magnetically-soft phases.

FIG. 2 is a schematic diagram of an example composite permanent magnet having alternating layers of magnetic phases.

FIG. 3 is a schematic diagram of another example composite permanent magnet having alternating layers of magnetic phases.

FIG. 4A is a schematic diagram depicting an assembly stage of an example method of forming a composite permanent magnet.

FIG. 4B is a schematic diagram depicting a hot compaction stage of an example method of forming a composite permanent magnet.

FIG. 4C is a schematic diagram depicting a hot deformation stage of an example method of forming a composite permanent magnet.

FIG. 5 is a flow chart showing an example method of forming a composite permanent magnet.

FIG. 6 is a schematic diagram depicting an additive manufacturing example method of forming a composite permanent magnet.

FIG. 7 is a schematic diagram of a further example composite permanent magnet having alternating layers of magnetic phases.

FIG. 8 is a schematic diagram of an example composite permanent magnet having a network structure of intermixed magnetic phases.

FIG. 9 is a plot depicting magnetic hysteresis curves of composite magnets both with and without having a nonmagnetic coating disposed about respective magnetically-soft phases.

FIG. 10 is a flow chart showing another example method of forming a composite permanent magnet.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary, the description of a group or class of materials by suitable or preferred for a given purpose in connection with the disclosure implies that mixtures of any two or more members of the group or class may be equally suitable or preferred.

Certain ferromagnetic materials do not fully return back to zero magnetization after an imposed magnetic field in a single direction is removed. The amount of magnetization the magnet retains with zero driving magnetic field is referred to herein as remanence. The magnetization must be driven back to zero by a field in the opposite direction. This amount of reverse driving field required to demagnetize the magnet is referred to as its coercivity. If an alternating magnetic field is applied to the material, its magnetization will trace out a loop known as hysteresis loop. A lack of retraceability of the magnetization demonstrates hysteresis properties in the magnet. This property may be considered as a magnetic “memory.” Discussed in more detail below, some compositions of ferromagnetic materials retain an imposed magnetization indefinitely and are useful as “permanent magnets.”

Material having high remanence and high coercivity from which permanent magnets are made may be referred to as “magnetically-hard.” Such materials may be contrasted with “magnetically-soft” materials from which nonpermanent magnetic components are formed (e.g., transformer cores and coils for electronics). A magnetically-hard material maintains its magnetic properties once magnetized and is difficult to demagnetize. Conversely, a magnetically-soft material is relatively easy to demagnetize, and many soft magnetic materials will begin to demagnetize as soon as an applied magnetic field is removed.

The higher coercivity of magnetically-hard materials makes them suitable for use where it may be undesirable for an applied magnetic field to demagnetize them. Hard magnetic materials are therefore suitable for use as permanent magnets (e.g., in a rotor of an electric machine) where they maintain the best utility for magnetic designs. In order to improve magnetic performance such as remanence and energy product of a composite permanent magnet, at least one magnetically-hard phase (e.g., Nd—Fe—B or Sm—Co) is interleaved between a plurality of aligned magnetically-soft phases (e.g., Fe and/or Fe—Co). Alternating layers between the magnetically-hard and magnetically-soft phases reduces the amount of magnetically-hard material required, thus reducing overall cost of the permanent magnet without sacrificing electromagnetic performance.

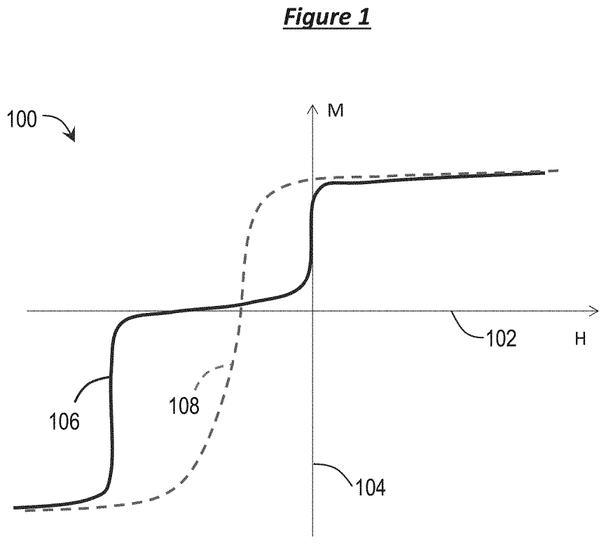

Referring to FIG. 1, plot 100 depicts magnetic properties of a composite permanent magnet according to the present disclosure. More specifically, plot 100 depicts a hysteresis loop plotted in the form of magnetization M as a function of driving magnetic field strength H. Horizontal axis 102 represents the strength of the driving magnetic field, H (e.g., represented in kA/m or Oe). The vertical axis 104 represents magnetization of the permanent magnet, J (e.g., represented in Tesla or Gauss). Curve 106 represents hysteresis curve for a permanent magnet having soft phase particles around 10 nm or smaller. Curve 108 is an idealized curve representing performance of textured magnetic material which may be difficult to form with small grain sizes. If the strictly controlled microstructure is achieved with the smaller grain size, it generates a good squareness as shown schematically by curve 108. The smoothness of the M-H curves also shows the coupling between the magnetically-hard phases and magnetically-soft phases, because alignment heavily impact performance in conventional permanent magnets.

The implantation of magnetically-soft phases into permanent magnets causes the deterioration of the magnetic performance of permanent magnets (i.e., significantly lower coercivity and remanence). Additionally, a kinked M-H curve make it is impossible for motor applications. For example, when the average grain size of the soft phase is larger than 20 to 50 nm, as represented by curve 106, the hysteresis loop will exhibit an undulation or kink, as shown in curve 106 of plot 100, indicating a lack of sufficient coupling between the magnetically-hard and magnetically-soft phases. One solution to realize the composite magnet with acceptable magnetic properties is reducing the crystalline grain size of magnetically-soft phase to nano-scale, i.e., tens of nanometers. Typical processes are ball milling, melt spinning.

The alloys from which permanent magnets are made may be difficult to handle metallurgically. Thus, the process of creating nano-scale grains may be less than practical to produce high performance magnets. That is, the materials may be mechanically hard and brittle. The materials may be cast and then ground into shape, or initially ground to a powder and subsequently formed into a desired shape. During the powder stage, the materials may be mixed with resin binders, compressed, and heat treated. Maximum anisotropy of the material is desirable, therefore the end materials are often heat treated in the presence of a strong magnetic field. Permanent magnets configured for electric motor applications may be solid sintered magnets or bonded magnets. Also, rare earth permanent magnets may be suitable for motor applications, but often carry higher costs. According to aspects of the present disclosure, it may be desirable to reduce rare earth magnet content without scarifying magnetic performance of the electric machine.

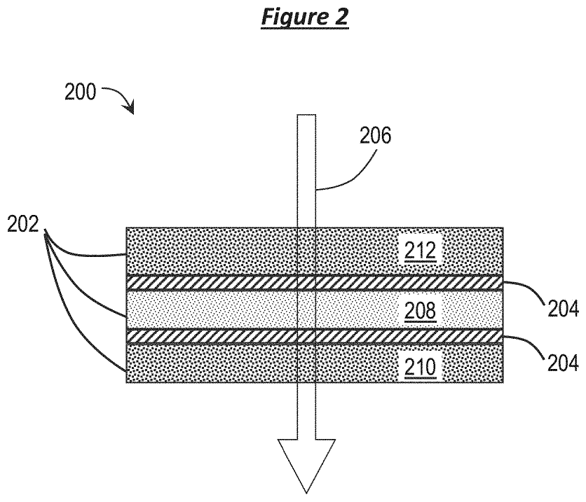

Referring to FIG. 2, a schematic diagram depicts an example composition of permanent magnet 200 according to the present disclosure. The permanent magnet 200 includes a plurality of magnetically-hard layers 202 interleaved between a plurality of a magnetically-soft layers 204. The magnetically-hard materials of layers 202 may be, but is not limited to, NdFeB, SmCos, MnBi, Sm—Fe—C, or other suitable permanent magnet materials or compounds, or combinations thereof. The materials of magnetically-soft layers 204 may be, but are not limited to, Fe, Co, FeCo, Ni, or combinations thereof. The magnetically-soft layers may also, in some examples, comprise a semi-hard magnetic phase, such as, but not limited to, Al—Ni—Co, Fe—N, an L10-material, Mn—Al, Mn—Al—C, Mn—Bi, or other similar materials. In further examples, the magnetically-hard phase may comprise a combination of materials, such as, but not limited to, a composite of Nd—Fe—B+a-Fe(Co), and may include an adjustable content of Fe(Co), SmCo+Fe(Co), off-eutectoid SmCo, NdFeB alloys, or other similar materials. In further examples, a magnetically-hard layers positioned near an outer surface of the finished composite permanent magnet 200 have distinct electromagnetic properties relative to magnetically-hard layers near a center portion of the finished magnet. Said another way, a first magnetically-hard layer is disposed at a first portion of the composite magnet and a second magnetically-hard layer having unique electromagnetic properties is disposed at a second portion of the composite magnet. In the context of the schematic of FIG. 2, magnetically-hard center layer 208 may have different electromagnetic properties relative to the magnetically-hard outer layers 210, 212.

The magnetically-soft layers 204 are incorporated with the magnetically-hard layers 202 such that the layers alternate between magnetically-hard and magnetically-soft layers. The layers may be joined my any number of methods, for example, such as being bonded to each other by an adhesive or joined by sintering. Related to this configuration, the thickness of the magnetically-soft layers may be thicker than nanoscale, yet still deliver desired permanent magnet performance. In some examples, the magnetically-soft layers may have a layer thickness significantly larger relative to the nanoscale sized particles associated with traditional composite magnets. More specifically, the magnetically-soft layers may provide suitable performance with submicron, micron, or even sub-millimeter thicknesses. This larger size reduces manufacturing costs and allows for alternative manufacturing methods. However, while exemplary thicknesses are provided by way of example, it is noted that the individual layers may have any suitable thickness and/or grain size on the scale of sub-microns as large as sub-millimeter.

Arrow 206 schematically represents the crystallographic texture of the magnetically-hard layers (i.e., that the c-axis of each of the magnetically-hard layers grains is aligned). For many magnetically anisotropic materials, the most convenient directions to magnetize the material are oriented 180 degrees rotated relative to each other. The line represented by arrow 206 may also be referred to as the easy axis, or the magnetized direction of the magnetically-hard phase. In some examples, the magnetically-soft layers 204 also have a crystallographic texture. Due to the high flux provided by the magnetically-soft phases, as depicted by the hysteresis loop in FIG. 1, the saturated polarization and remanence of the resulting permanent can be improved. Further, because of the increased dimensions of the magnetically-soft layers, a composite magnet with magnetically-hard and magnetically-soft phases can be produced with improved texture, which cannot be realized in conventional permanent magnets. According to some examples the combination of the magnetically-hard layers and the magnetically-soft layers forms an anisotropic internal structure for the overall finished composite magnet.

As used herein, average grain size is referred to interchangeably as “grain size,” and is defined as a minimum dimension of the particle (e.g., the average diameter of a sphere, etc.). Controlling the grain size and shape to a desired configuration may provide an improved magnetic performance in the finished permanent magnet. Similarly, the shapes of the individual grains of material of the magnetically-hard layers may include, but are not limited to, oval or elliptical shapes, and/or a flake shapes. The magnetically-hard grains may also include a mixture of rectangular shapes and oval shapes, or include all grains of a single type of shape. In some examples, the magnetically-hard phase includes grains having a spherical shape having a diameter of smaller than the width of elongated grains. The shape of grains may affect performance in numerous ways, such as, but not limited to, improving grain boundaries, providing high texture areas, providing magnetic aesthetic interaction resulting in grain elongation

In order to improve coupling between the magnetically-hard and magnetically-soft phases, as well as improve the uniformity of the layers, the shape of the magnetically-soft phase is provided as a monolithic layer. The magnetically-soft layers 204 are depicted in the figures as having a completely flat, uniform rectangular shape, but may be provided with any suitable shape. For example, the sheet material may have an undulated shape and/or other geometric shape patterns pre-formed in the sheet material.

The thickness of the magnetically-soft layers 204 need not necessarily be nanoscale. That is the magnetically-soft layers may be provided with a submicron thickness, multi-micron thickness, or even sub millimeter thickness without sacrificing magnetic performance. The processes to produce this type of anisotropic composite magnet is achievable using simpler manufacturing techniques compared to previous arts. Discussed in more detail below, sintering processes, hot-deformation processes, and additive manufacturing processes (i.e., “3D printing”) may all be suitable alternatives to manufacture permanent magnets according to the present disclosure. According to some alternate examples, the magnetically-hard layers 202 are compacted and pre-sintered prior to be assembled (e.g., bonded) to the mechanically-soft layers 204 (e.g., monolithic sheet material). According to other alternate examples, the magnetically-soft layers 204 may be formed from a semi-hard magnetic material, or even different type of magnetically-hard material having desired properties.

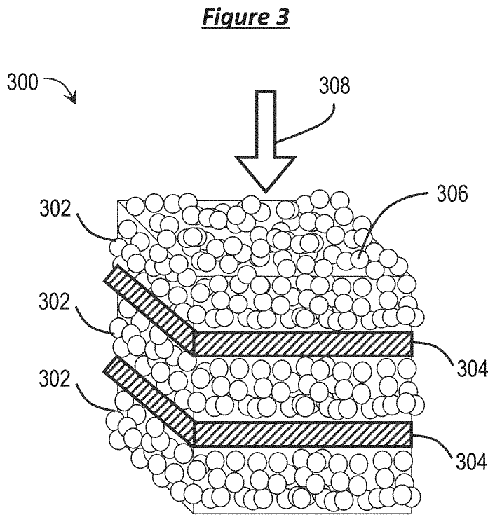

Referring to FIG. 3, a composite magnet 300 is formed by sintering multiple layers following compaction. The magnetically-hard layers 302 are formed from a powdered material 306 applied between each of the magnetically-soft layers 304. An adhesive material such as glue, epoxy or other binding medium, may be applied at each layer to adhere the powdered material 306 to adjacent layers. Each of the layers may be applied by alternating between layer types at each adjacent layers. The individual grains of the powdered material 306 are depicted as spherical in FIG. 3, but the shapes may be formed during compaction to become flatter and more oblong in the finished permanent magnet 300. Moreover, pressure and a magnetic field may both be applied during manufacturing along a direction represented by arrow 308 to induce a desired crystallographic structure. Following compaction at room temperature to consolidate the powdered material 306, the composite magnet 300 may be sintered to complete the bonding between layers.

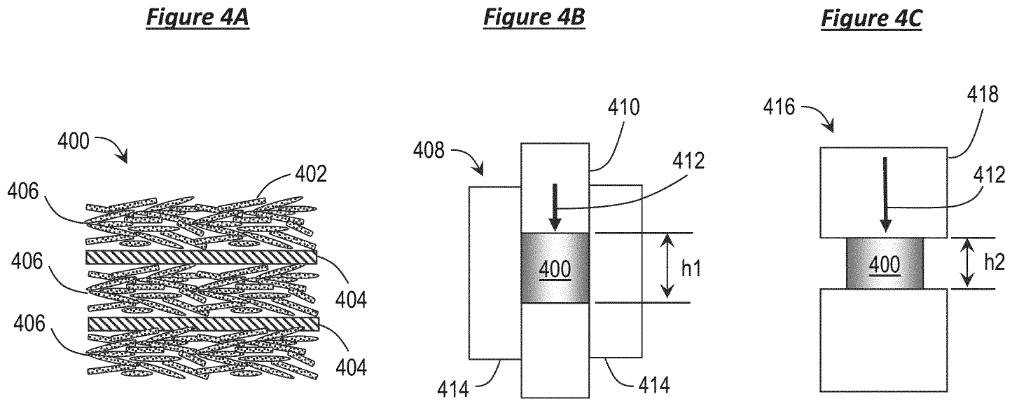

Referring collectively to FIG. 4A through FIG. 4C, a composite magnet 400 is formed by hot deformation. Magnetically-hard flakes 402 are applied in an alternating fashion between magnetically-soft layers 404. Once processed, the regions comprising the magnetically-hard flakes 402 form magnetically-hard layers 406. The grain shape of the magnetically-hard flakes 402 may be an elongated shape, such as, but not limited to, an elliptical shape, rectangular shape, or layered shape. Similar to examples discussed above, the grains of the magnetically-hard layer may be initially provided as having a different grain shape (e.g., spherical) while unprocessed and then become flattened during deformation.

With specific reference to FIG. 4B, the layers 404 and 406 are combined via hot compaction to consolidate the powdered portions of the composite magnet 400. According to some examples, pressure is applied in a closed die 408 upon a column of layered materials such as that described above in reference to FIG. 4A, including the loose metal particles of magnetically-hard flakes 402. Pressure is applied by a plunger 410 arranged to advance along the direction of arrow 412. When the metal powders are pressed within the closed die 408, they generally may flow in the direction of the applied pressure and the individual grains may become oriented normal to the direction of compaction. The closed die 408 also includes side walls 414 that hold the lateral portions of the composite magnet 400 during compaction.

Heat is also applied during the compaction process of FIG. 4B improve the malleability of the materials for forming. While in the die 408, and during compaction, the magnetically-hard layers 406 and the magnetically-soft layers 404 are heated to a temperature above which the materials no longer remain work-hardened (e.g., 600 to 850° C.). Hot pressing under controlled conditions also provides an advantage in that the heat generally lowers the pressures required to fully consolidate the powder material and reduce porosity due to any gaps in the powder. The magnetically-soft layers may also be conformed to fill any gaps or conform to shape irregularities in adjacent layers.

Referring to FIG. 4C, hot deformation is applied to further develop the texture of composite magnet 400 and improve its anisotropic properties. The hot deformation develops texture to a desired microstructure. The workpiece of composite magnet 400 may be transferred to a second deformation die 416 configured to cause a grain deformation process. A plunger 418 is advanced along direction 412 to deform the composite magnet 400. The hot deformation die 416 is provided without sidewalls to allow the composite magnet 400 to expand laterally as it is compressed along the direction of arrow 412. Shown by way of the schematic of FIG. 4B and FIG. 4C, the composite magnet is plastically deformed from a height of h1 in FIG. 4B, to a reduced height of h2 in FIG. 4C.

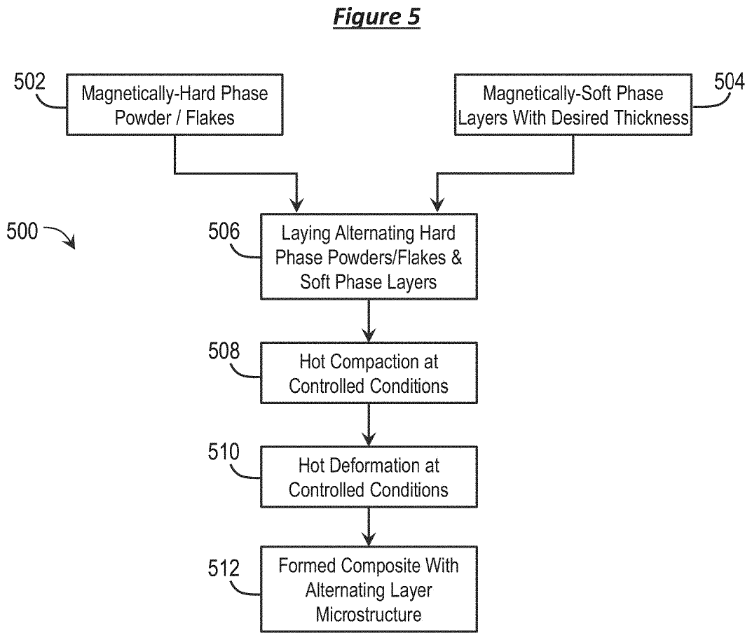

Referring to FIG. 5, flowchart 500 represents a method of forming a permanent magnet having magnetically-hard and magnetically-soft phases. At step 502, a predetermined volume of flakes or powders of a magnetically-hard phase is provided. The flakes or powders of the magnetically-hard phase may be prepared by any suitable technique to achieve initial magnetically-hard phases with small grain size, such as, but not limited to, melt-spinning. By utilizing a small grain size in the magnetically hard phase, the desired grain growth can be better controlled during subsequent processing steps. According to some examples where the magnetically-hard phase is in powder form, the powder may be an HDDR powders having a nano-scale grain size. The magnetically-hard phase may be, but is not limited to, Nd—Fe—B and Sm—Co. In other examples, the magnetically-hard particles may include a predetermined proportion of rare-earth rich particles.

At step 504, the magnetically-soft phase is provided. The magnetically-soft phase may be applied as a monolithic layer having a desired thickness. According to some examples, the thickness is designed based on the desired final properties of the finished composite magnet. Due to the alternating construction of the magnet, the thickness of the magnetically-soft layers may be thicker for example, from submicron up to millimeter scale. More specifically, the thickness of the magnetically-soft layers may be 0.1 micron, 1 micron, 0.1 mm, 0.5 mm, 1.0 mm or greater. Also, the magnetically-soft layer may be, but are not limited to, Fe, Co, or Fe—Co. In some alternate examples, the magnetically-soft layers may instead be formed from a semi-hard magnetic material, or even a distinct type of magnetically-hard material with desired properties.

At step 506, powder or flakes of the magnetically-hard phase from step 502 are applied to the monolithic layers the magnetically-soft phase from step 504 in an alternating fashion. That is, the magnetically-hard powder or flakes are interleaved between the magnetically-soft layers.

At step 508 the preassembled composite magnet is placed in a die and hot compacted to consolidate the powered portions and interleaved magnetically-soft layers, as well as achieve the desired overall magnet shape. The hot compaction at step 508 may be controlled by temperature, pressing time, and pressing pressure, wherein each parameter may be dependent on the other parameters. For example, in some embodiments, where the temperature could be 550 to 800° C., the pressing time may be from 5 to 30 minutes, and the pressure may be 100 MPa to 2 GPa.

At step 510 the compacted magnet is hot deformed to induce the desired microstructure. As described above, the individual grains of the powdered layers may be formed into a desired shape and orientation. The hot deformation step 510 may be controlled by temperature, time, pressure, and deformation speed. For example, in some embodiments, the temperature may be 600 to 850° C., the pressing may be 5 to 60 minutes, and the pressure may be 100 MPa to 1 GPa. The deformation speed is thus controlled by the pressure increasing speed or the displacement speed of the press ram or plunger. With the hot compaction and hot deformation process, a crystallographic microstructure texture of magnetically hard phase may be developed at step 512.

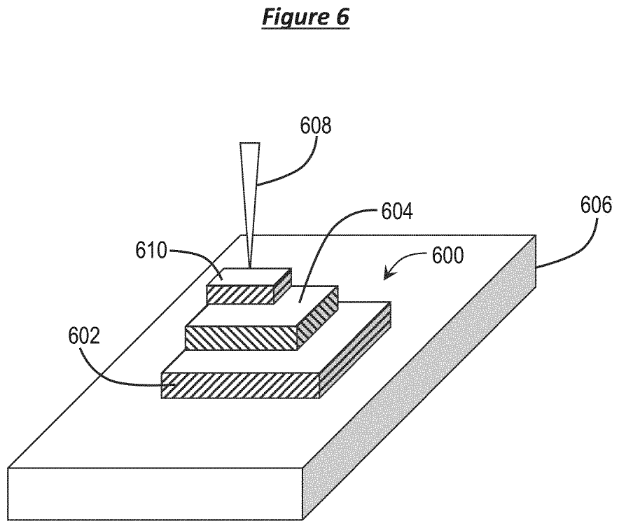

Referring to FIG. 6, an additional example composite magnet 600 is schematically represented. The composite magnet is shown as partially cutaway in order to depict the construction used to form the interleaved layers. In the case of FIG. 6, the composite magnet is formed using additive manufacturing. In some examples powder bed fusion (PBF) technology may be used to sinter the powered material. In specific examples PBF may be used in various additive manufacturing processes, including for example, direct metal laser sintering (DMLS), selective laser sintering (SLS), selective heat sintering (SHS), electron beam melting (EBM), and direct metal laser melting (DMLM). Additionally, sheet lamination may be applied in conjunction with additive manufacturing processes. These systems use lasers, electron beams, thermal print heads, or other heating mediums to melt or partially melt ultra-fine layers of material in a three-dimensional space. As each process concludes, any excess powder can be cleaned from the object. One advantage of utilizing additive manufacturing processes is the ability to create complex designs that include intricate features that are expensive, difficult, or even impossible to construct using traditional dies, molds, milling and machining.

A first magnetically-hard layer 602 is formed from a predetermined volume of particles similar to previous embodiments. However, in the example of FIG. 6, the particles are solidified by placement of powdered composite material upon an additive manufacturing bed 606. A laser 608 is activated to partially melt the powered composite material to cause the creation of a solid component. A three-dimensional structure is then built up by sequentially adding layers upon previous layers. Each successive layer bonds to the preceding layer of melted or partially melted material.

Once the first magnetically-hard layer 602 is built up to the desired thickness, a magnetically-soft layer 604 is applied. The magnetically-soft layer 604 may be a monolithic sheet-like material similar to previous examples. A suitable sheet material may be provided in an ongoing fashion to such as dispensed from a bulk roll of sheet material located at the additive manufacturing workstation. The sheet may be dispensed, placed, cut, and adhered to the previous layer, as well as other preparation steps, prior to activating the laser to at least partially melt the magnetically-soft layer 604. The laser is then activated to sinter the magnetically-soft layer 604 and bond it to the previously-formed first magnetically-hard layer 602. In alternate examples, one or more of the magnetically-soft layers may be applied as a powder or other particulate having desired soft magnetic properties where the laser solidified each magnetically-soft layer atop the previous magnetically-hard layer.

Once the magnetically-soft layer 604 is fully applied, a second magnetically-hard layer 610 may be applied by locating a powdered composite material upon the topmost layer and once again activating the laser 608 to sinter the power and bond it to the interleaved magnetically-soft layer 604. This process may be repeated, alternating between magnetically-hard and magnetically-soft materials to provide a microstructure with desired magnetic properties. In some examples, once a composite magnet 600 achieves a desired overall volume, the workpiece may be post-processed for example using hot deformation with or without an external magnetic field applied to influence the orientation of the polarity of the composite magnet 600.

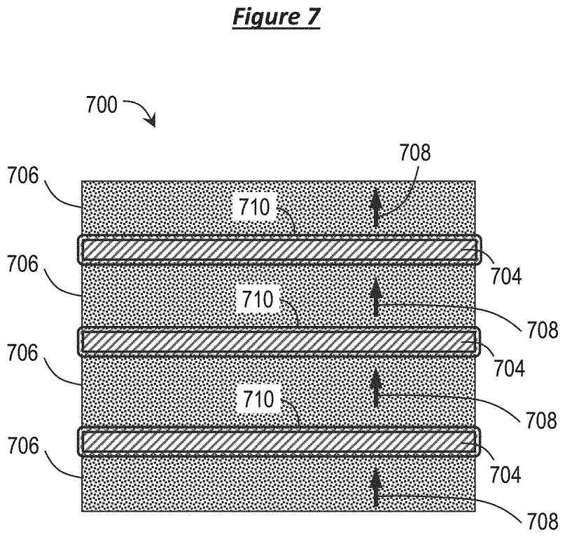

Referring to FIG. 7, an additional example composite magnet 700 is depicted schematically. Similar to previous examples, the composite magnet 700 includes a composition alternating between magnetically-hard layers 706 and magnetically-soft layers 704. Each of the magnetically-hard layers 706 may be formed from a predetermined volume of powder, flakes, or other particulate of magnetically-hard materials. The magnetically-hard layers 706 may be consolidated via hot compaction and the internal texture of the layers 706 may be formed to a desired texture via hot deformation. Also similar to previous examples, the anisotropic direction of the magnetically-hard phases may be influence by the processing techniques, including for example, the hot deformation process and/or the application of a magnetic field during manufacturing of the composite magnet. According to the example of FIG. 7, the easy axis of the composite magnet 700 is indicated by direction of arrows 708.

Each of the magnetically-soft layers 704 includes an outer coating 710 applied to an outer surface. By introducing a thin coating layer circumscribing the magnetically-soft layers 704, the demagnetization process of the magnetically-hard phases 706 can be inhibited or postponed. As a result, the coercivity of the finished composite magnet can be improved. The outer coating portion 710 is formed from a nonmagnetic material, such as carbon (C), or metals such as Cu, Al, or the like. In some examples, the thickness of the outer coating 710 is very thin such as a few nanometers.

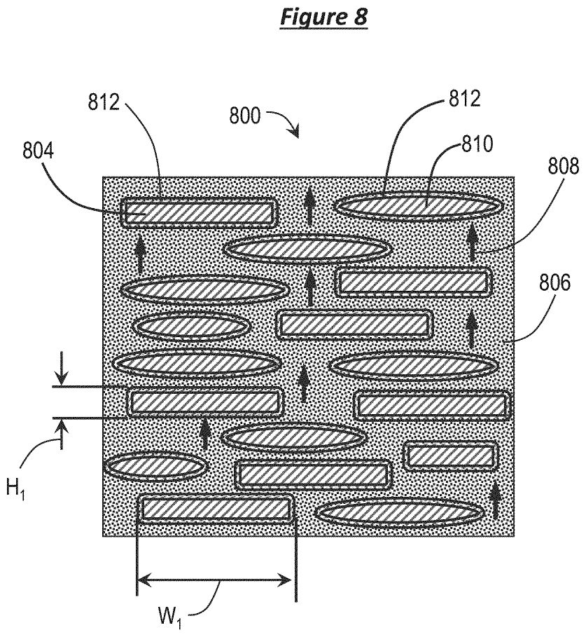

Referring to FIG. 8, a further example composite magnet 800 is depicted schematically. In the example of FIG. 8, the composite magnet 800 is formed from a network structure as opposed to strict alternating layers. Composite magnet 800 includes a magnetically-soft phase 804 and a magnetically-hard phase 806. The magnetically-hard phase 806 may be, but is not limited to, NdFeB, SmCo₅, MnBi, Sm—Fe—C, or other suitable permanent magnet materials or compounds, or combinations thereof. The magnetically-soft phase 804 may be, but is not limited to, Fe, Co, FeCo, Ni, or combinations thereof. The magnetically-soft phase may, in some embodiments, be a semi-hard magnetic phase, such as, but not limited to, Al—Ni—Co, Fe—N, an L10-material, Mn—Al, Mn—Al—C, Mn—Bi, or other similar materials. Moreover, in some embodiments, the hard phase may comprise a combination of materials, such as, but not limited to, a composite of Nd—Fe—B+a-Fe(Co), and may include an adjustable content of Fe(Co), SmCo+Fe(Co), off-eutectoid SmCo, NdFeB alloys, or other similar materials. The magnetically-soft phase 804 is incorporated into the magnetically-hard phase 806 such that the average grain size of the magnetically-soft phase 804 is larger than conventional permanent magnets. The arrows 808 in the hard phase of FIG. 8 schematically show the crystallographic texture of the magnetically-hard phase (i.e., that the c-axis of the magnetically hard phase grains is aligned).

According to some examples, the magnetically-hard phase 806 may have a grain size of 10 nm to 100 μm, in some embodiments, 50 nm to 50 μm, and in other embodiments 75 nm to 25 μm. Although exemplary ranges are provided, it is noted that the magnetically-hard phase may have any suitable grain size on the scale of tens of nanometers to tens of microns. The grain size and shape of the magnetically-soft phase 804 provides improved magnetic performance in the final permanent magnets. In order to achieve good coupling between the magnetically-hard and magnetically-soft phases, the shape of the magnetically-soft phases 804 may be an elongated shape, such as, but not limited to, an elliptical shape, irregular flake shape, rectangular shape, or layered shape. In certain examples, the magnetically-soft phase grains have a grain size of at least 50 nm, in other embodiments 50 to 1000 nm, and in yet other embodiments, at least 75 nm. In further examples, the magnetically-soft phase 804 includes grains having an average grain height H₁ of about 20 to 500 nm, in some embodiments about 30 to 200 nm, and in other embodiments about 50 to 500 nm. Additionally, the magnetically-soft phase includes grains having an average grain width W₁ of at least 50 nm, in some embodiments at least 100 nm, and in other embodiments 100 to 1000 nm.

The shape of individual grains may affect performance in numerous ways, such as, but not limited to, improving grain boundaries, providing high texture areas, providing magnetic aesthetic interaction resulting in grain elongation. The magnetically-soft phase 804 is shown as a rectangular shape, but may be any suitable shape, such as, but not limited to, an oval or elliptical shape 810, a layered shape (discussed above), or a flake shape (not shown). The magnetically-soft grains may include a mixture of the rectangular shapes such as those depicted for magnetically-soft phase 804 and the oval or elliptical shapes 810, or include all grains of a single shape. In some examples, the magnetically-soft phase 804 initially includes grains of a spherical shape having a diameter of smaller than the width of the elongated grains. Also discussed above, the spherical shape may be formed to become elongated during hot deformation. For example, the diameter may be less than about 500 nm, and in other examples the diameter may be less than about 250 nm. In some examples, the elongated shape of the magnetically-soft grains can be characterized by an aspect ratio of the grains as a ratio of grain width (W) (or length) to grain height (H). In a specific example, the magnetically-soft phase defines a grain aspect ratio greater than 2:1, and in further examples the grain aspect ratio may be greater than 10:1.

The magnetically-soft phase 804 also includes a nonmagnetic outer coating 812 formed about each of the individual grains. According to the example of FIG. 8, an outer coating 812 circumscribes each grain of the magnetically-soft phase 804. As discussed above, the introduction of a thin coating layer on the magnetically-soft layers 804 may help to postpone the demagnetization process of the magnetically-hard phase 806.

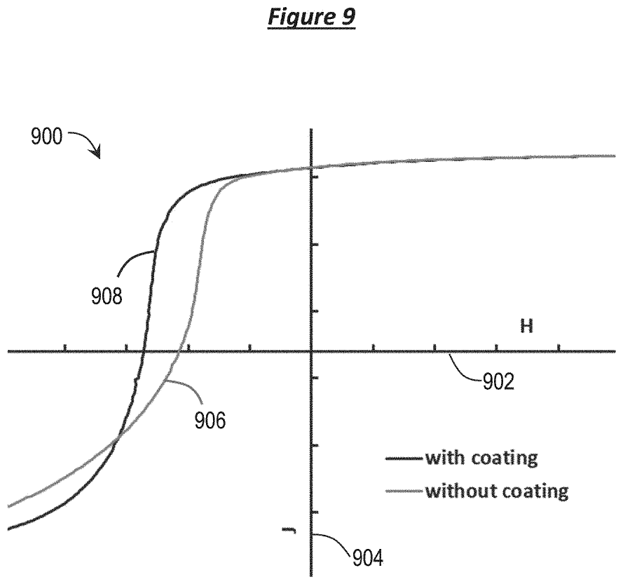

Referring to FIG. 9, a plot 900 depicts magnetic properties of a composite permanent magnet according to the present disclosure. Plot 900 depicts a hysteresis loop plotted in the form of magnetization M as a function of driving magnetic field strength H. Horizontal axis 902 represents the strength of the driving magnetic field, H (e.g., represented in kA/m or Oe). The vertical axis 904 represents magnetization of the permanent magnet, J (e.g., represented in Tesla or Gauss). Curve 906 represents hysteresis curve for a permanent magnet having uncoated magnetically-soft phase particles. Curve 908 is an idealized curve representing performance of a composite magnet having coated magnetically-soft phases. The specimen corresponding to curve 908 demonstrates approximately 20% improved coercivity relative to specimen having noncoated magnetically-soft phases corresponding to curve 906.

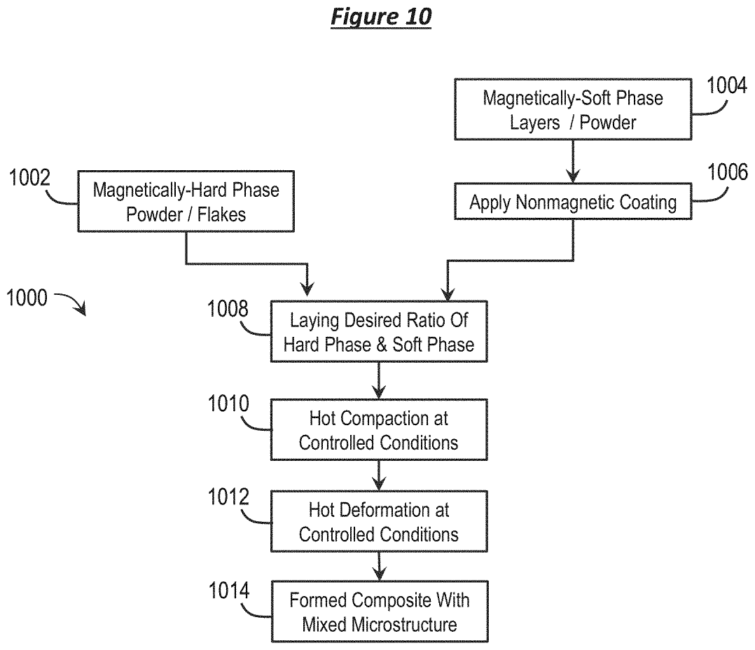

Referring to FIG. 10, flowchart 1000 represents a method of forming a permanent magnet having magnetically-hard and coated magnetically-soft phases. At step 1002, a predetermined volume of flakes or powders of a magnetically-hard phase is provided. The flakes or powders of the magnetically-hard phase may be prepared by any suitable technique to achieve initial magnetically-hard phases with small grain size, such as, but not limited to, melt-spinning. By utilizing a small grain size in the magnetically hard phase, the desired grain growth can be better controlled during subsequent processing steps. According to some examples where the magnetically-hard phase is in powder form, the powder may be an HDDR powders having a nano-scale grain size. The magnetically-hard phase may be, but is not limited to, Nd—Fe—B and Sm—Co. In other examples, the magnetically-hard particles may include a predetermined proportion of rare-earth rich particles.

At step 1004, the magnetically-soft phase is provided. The magnetically-soft phase may be applied as a monolithic layer having a desired thickness, or alternatively, the magnetically-soft phase may be provided as particles. In further examples, the magnetically-soft layers may instead be formed from a semi-hard magnetic material, or even a distinct type of magnetically-hard material with desired properties.

At step 1006 the materials of the magnetically-soft phase, whether provided as particles or sheet material, is coated prior to combination with the magnetically-hard materials. As discussed above, the coating may be any suitable nonmagnetic material, such as carbon, or metals such as Cu, Al, or the like.

At step 1008 the magnetically soft material is combined with the magnetically-hard material. As described above, the magnetically-soft phase may be provided as monolithic layers interleaved between layers of magnetically-hard phases. In other examples the magnetically-soft material and the magnetically-hard material are both provided as powder or flakes. In this example, materials are mixed at the powder state with a predetermined ratio.

At step 1010 the preassembled composite magnet is placed in a die and hot compacted to consolidate the powered portions and interleaved magnetically-soft layers, as well as achieve the desired overall magnet shape. As discussed above, the hot compaction at step 1010 may be controlled by temperature, pressing time, and pressing pressure, wherein each parameter may be dependent on the other parameters.

At step 1012 the compacted magnet is hot deformed to induce the desired microstructure. As described above, the individual grains of the powdered layers may be formed into a desired shape and orientation. The hot deformation step 1012 may be controlled by temperature, time, pressure, and deformation speed. With the hot compaction and hot deformation process, a crystallographic microstructure texture of magnetically hard phase may be developed at step 1014.

According to some examples, a composite permanent magnet includes a magnetically-hard phases interleaved between magnetically-soft layers, wherein, in some embodiments, the grain size of the magnetically soft phase may be larger than 50 nm. Additionally, the grain shape of the magnetically-hard phases may be an elongated shape, such as, but not limited to, an oval shape, an elliptical shape, a layered shape, a flake shape, or a spherical shape (with a controlled diameter). Further, the composite permanent magnet is formed to include an anisotropic texture having a predetermined easy axis orientation. One particular advantage of the present disclosure stems from the size and shape difference between the grains of the magnetically hard and soft phases. Furthermore, the microstructure of the magnetically-hard phases and magnetically-soft phases provides a good coupling, thus improving performance, such as remanence and energy product, of the composite permanent magnet.

In further examples, a composite permanent magnet includes a magnetically-soft phase that is provided with a non-metallic coating prior to combination with the magnetically-hard phase. In some specific examples, the non-metallic phase is provided as powder or flakes. In other examples, the magnetically-soft phase is provided as a monolithic sheet material. Once combined, the magnetically-soft phase is isolated from the magnetically-hard phase via the outer coating applied to portions of the magnetically-soft phase.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A composite permanent magnet comprising:
at least one first portion formed from a magnetically-hard material;
at least one second portion formed from a magnetically-soft material intermixed with the first portion at a predetermined ratio; and
an outer coating portion formed from a nonmagnetic material circumscribing each second portion, wherein each outer coating portion isolates a second portion from the at least one first portion thereby inhibiting demagnetization of the at least one first portion.

2. The composite permanent magnet of claim 1, wherein the at least one first portion is a matrix of magnetically-hard material, the at least one second portion is a plurality of magnetically-soft grain particles, and the magnetically-soft grain particles are embedded within the matrix.

3. The composite permanent magnet of claim 2 wherein the plurality of magnetically-soft grain particles having an average grain width of at least 50 nm, and an average grain height of about 20 to 500 nm

4. The composite permanent magnet of claim 1, wherein the at least one first portion is a plurality of compacted powder layers, the at least one second portion is a plurality of monolithic layers of sheet material, and the compacted powder layers are interleaved between the monolithic layers of sheet material.

5. The composite permanent magnet of claim 4, wherein a first compacted powder layer is disposed near an outer portion of the composite permanent magnet and a second compacted powder layer is disposed near a center portion of the composite permanent magnet, and the first compacted powder layer provides unique electromagnetic properties relative to the second compacted powder layer.

6. The composite permanent magnet of claim 1, wherein the magnetically-hard material is formed from at least one of NdFeB, SmCos, MnBi, Sm—Fe—C, or combinations thereof.

7. The composite permanent magnet of claim 1, wherein the magnetically-soft material is formed from at least one of Fe, Co, FeCo, Ni, or combinations thereof.

8. The composite permanent magnet of claim 1, wherein the outer coating portion is formed from at least one of C, Cu, Al, or combinations thereof.

9. The composite permanent magnet of claim 1, wherein a combination of the at least one first portion and the at least one second portion forms an anisotropic internal structure of the composite permanent magnet.

10. A composite permanent magnet comprising:
at least one magnetically-hard portion formed from a compacted powder material;
at least one magnetically-soft portion mixed with the at least one magnetically-hard portion; and
a nonmagnetic outer coating portion applied to each magnetically-soft portion to isolate the coated magnetically-soft portion from magnetically-hard portions thereby inhibiting demagnetization of the at least one magnetically-hard portion.

11. The composite permanent magnet of claim 10, wherein the at least one magnetically-hard portion is a matrix of particles, the at least one magnetically-soft portion is a plurality of magnetically-soft grain particles, and the magnetically-soft grain particles are embedded within the matrix.

12. The composite permanent magnet of claim 10, wherein the compacted powder material is formed in a plurality of layers, the at least one magnetically-soft portion is a plurality of monolithic layers of sheet material, and the layers of compacted powder are interleaved between the monolithic layers of sheet material.

13. The composite permanent magnet of claim 12, wherein a first compacted powder layer is disposed near an outer portion of the composite permanent magnet and a second compacted powder layer is disposed near a center portion of the composite permanent magnet, and the compacted powder layer provides unique electromagnetic properties relative to the second compacted powder layer.

14. The composite permanent magnet of claim 10, wherein at least one magnetically-hard portion includes elongated particles at least partially shaped during hot deformation.

15. A method of forming a composite permanent magnet comprising:
providing a powder of magnetically-hard grains to form a first portion;
providing a magnetically-soft material to form a second portion;
applying a nonmagnetic coating to the second portion;
mixing the first portion and the coated second portion to a predetermined ratio;
hot-compacting the first portion and the second portion to form a compact; and
hot-deforming the compact to form a composite permanent magnet with elongated magnetically-hard grains embedded within an internal texture of the composite permanent magnet.

16. The method of claim 15, wherein hot-compacting is conducted at a temperature of about 550-800 degrees C., for a pressing time of about 5 to 30 minutes, under a pressure of about 100 MPa to 2 GPa.

17. The method of claim 15, wherein hot-deforming is conducted at a temperature of about 600-850 degrees C., for a pressing time of about 5 to 60 minutes, under a pressure of about 100 MPa to 1 GPa.

18. The method of claim 15, wherein the second portion is provided as a monolithic sheet material and mixing the first portion and the coated second portion comprises providing alternating layers of the first portion and the second portion.

19. The method of claim 15, wherein the first portion is provided as a matrix of magnetically-hard material, second portion is provided as a plurality of magnetically-soft grain particles, and mixing the first portion and the coated second portion comprises embedding the magnetically-soft grain particles are within the matrix.

20. The method of claim 15 further comprising applying a magnetic field to the first portion and the second portion during assembly to promote an anisotropic internal structure of the composite permanent magnet.
